(19) United States
(12) Patent Application Publication
(10) Pub. No.: US 2012/0249227 A1
(43) Pub. Date: Oct. 4, 2012

(54) VOLTAGE LEVEL GENERATOR CIRCUIT

(75) Inventors: Ryo NAKAYAMA, Odawara (JP); Masaki Yoshinaga, Hino (JP); Yoshitaka Abe, Hitachinaka (JP); Kenji Hirayama, Hamura (JP); Yoshihiro Hayashi, Tachikawa (JP)

(73) Assignee: HITACHI, LTD.

(21) Appl. No.: 13/350,795

(22) Filed: Jan. 15, 2012

(30) Foreign Application Priority Data
Mar. 30, 2011 (JP) 2011-073874

(51) Int. Cl. G05F 3/02

(52) U.S. Cl. 327/543

(57) ABSTRACT

A voltage level generator circuit comprised of a fixed voltage generator unit for generating a first electrical current in a fixed quantity from a first supply voltage; a first current mirror circuit unit including a first thin-film NMOSFET and a second thin-film NMOSFET and that outputs a second electrical current proportional to the first electrical current; a protective circuit including: a third thin-film NMOSFET and a first thick-film PMOSFET utilized as a grounded gate for protecting the second thin-film NMOSFET, a first diode for preventing inverse current flow to the first supply, and a second diode for preventing the gate-source voltage of the third thin-film NMOSFET from reaching a negative electrical potential; and a second current mirror circuit for outputting a third electrical current proportional to the second electrical current; and a first Zener diode unit for generating a first fixed voltage from a third electrical current.

### CLAIM OF PRIORITY

The present application claims priority from Japanese patent application JP 2011-073874 filed on Mar. 30, 2011, the content of which is hereby incorporated by reference into this application.

### FIELD OF THE INVENTION

The present invention relates to a voltage level generator circuit.

### BACKGROUND OF THE INVENTION

One widely known method for generating a fixed voltage that is lower than the supply voltage from the supply voltage serving as the reference is the resistor divider method. In this method when attempting to generate a fixed voltage from a high-voltage supply voltage, the current must be lowered in order to achieve low power consumption and the resistance must be increased to a large value. However increasing the resistance value causes the resistor element to occupy a large surface area in the case for example where using an integrated circuit. Moreover, when using the resistor divider method and the supply voltage serving as the reference voltage fluctuates, then the fixed voltage that is output will also fluctuate.

Another known method on the other hand, generates a fixed current by utilizing a current mirror circuit and generates a fixed voltage by shorting this fixed current with the gate and drain of a MOS device (See for example Japanese Unexamined Patent Application Publication No. 2009-021904.)

### SUMMARY OF THE INVENTION

When attempting to generate a fixed electrical current from a high-voltage supply voltage by using the current mirror circuit method, a thick-film MOSFET having a high breakdown voltage is utilized in the section that supplies the high-voltage supply voltage. However, the threshold voltage Vth in the thick-film MOSFET is high and so cannot be turned on or off by low-voltage logic circuits. High threshold voltage MOSFET therefore cannot be utilized as elements in current mirror circuits for copying the reference current generated by utilizing the resistance from signal input sections or low voltage supplies. Thin-film MOSFET devices possessing a low threshold voltage Vth are therefore utilized instead.

Thin-film MOSFET however are devices with a low breakdown voltage (minimum voltage that causes electrical breakdown and conductivity) and therefore require some scheme for breakdown voltage protection utilizing a circuit that generates a fixed voltage from the high-voltage supply voltage. A MOSFET that serves as a gate ground may for example have to be connected in series. The technology disclosed in Japanese Unexamined Patent Application No. 2009-021904 describes a voltage level generator circuit containing a MOSFET that operates as a gate ground for protecting MOSFET having a low breakdown voltage. Generating the gate voltage for the gate ground however requires providing a voltage from an external power supply.

In view of the above described problems with the related art, the present invention therefore has the object of providing a voltage level generator circuit not requiring an external power supply for generating a gate voltage for the gate ground, in MOSFET configured to operate as gate grounds for protecting MOSFET having a low breakdown voltage.

Representative aspects of the present invention are described as follows.

Namely, the voltage level generator circuit of the present invention is comprised of a fixed current generator unit for generating a first electrical current in a fixed quantity from a first supply voltage; a first current mirror circuit unit including: a first thin-film NMOSFET that is supplied a first electrical current via a drain, the drain is connected to a gate, and whose source is connected to a second supply voltage, and a second thin-film NMOSFET whose gate is connected to the first thin-film NMOSFET, whose source is connected to the second supply voltage, and that outputs a second electrical current proportional to the first electrical current; a protective circuit unit including: a third thin-film NMOSFET whose source is connected to the drain of the second thin-film NMOSFET, a first diode whose anode is connected to the first supply voltage and whose cathode is connected to the gate of the third thin-film NMOSFET, a second diode whose anode is connected to the source of the third thin-film NMOSFET and whose cathode is connected to the gate of the third thin-film NMOSFET, and a first thick-film NMOSFET whose source is connected to the source of the third thin-film NMOSFET and whose drain is connected to the drain of the third thin-film NMOSFET; a second current mirror circuit unit including: a first thick-film PMOSFET whose source is connected to a third supply voltage, whose drain is connected to the drain of the third thin-film NMOSFET, and whose gate is connected to the drain, and a second thick-film PMOSFET whose gate is connected to the gate of the first thick-film PMOSFET, whose source is connected to a third supply voltage, and that outputs a third electrical current proportional to the second electrical current; and a first Zener diode unit comprised of n number of first Zener diodes, whose anodes are connected to the second voltage supply and whose cathodes are connected to the drain of the second thick-film PMOSFET.

The present invention configured as above is capable of providing a voltage level generator circuit not requiring an external power supply for protecting thin-film MOSFET having a low breakdown voltage.

### BRIEF DESCRIPTION OF THE DRAWINGS

FIG. 1 is a circuit diagram showing an example of the structure of the voltage level generator circuit of the first embodiment;

FIG. 2A through 2I are examples of waveforms for showing the operation of the first embodiment;

FIG. 3 is a circuit diagram showing an example of the structure of the voltage level generator circuit of the second embodiment;

FIG. 4 is a circuit diagram showing an example of the structure of the voltage level generator circuit of the third embodiment;

FIG. 5 is a block diagram of the entire fourth embodiment.

### DETAILED DESCRIPTION OF THE PREFERRED EMBODIMENTS

The embodiments of the present invention are described next while referring to the drawings.

### First Embodiment

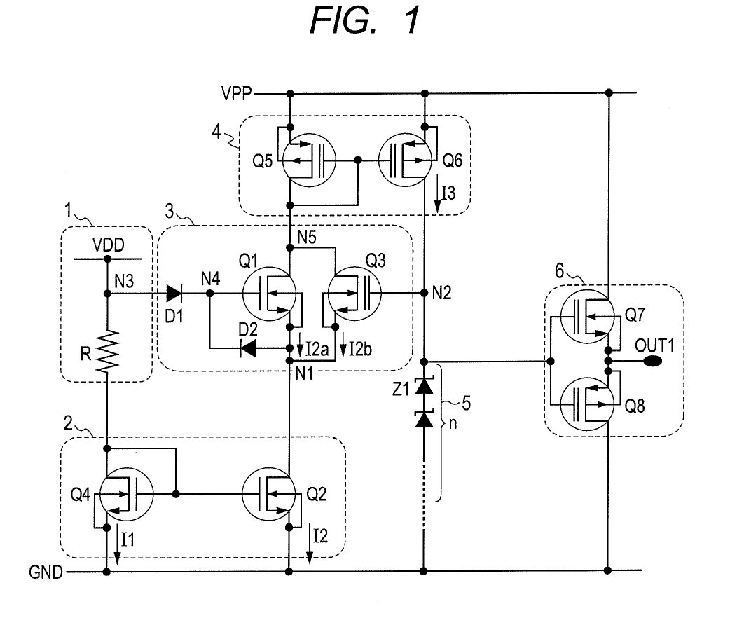

FIG. 1 shows the voltage level generator circuit of the first embodiment. The voltage level generator circuit is comprised of a fixed current generator unit 1, a current mirror circuit unit 2, a protective circuit unit 3, a current mirror circuit unit 4, a Zener diode unit 5, and a push-pull circuit 6.

In the following description, the term thick-film MOSFET indicates a MOSFET with a relatively thick gate insulation film, and the term thin-film MOSFET indicates a MOSFET with a relatively thin gate insulation film. The thick-film MOSFET is a high-voltage MOSFET with a comparatively high breakdown voltage and is a MOSFET capable of handling voltages between approximately 0 to 300 volts applied to the gate. The thin-film MOSFET is a low-voltage MOSFET having a low breakdown voltage, and capable of handling voltages of approximately 0 to 5 volts applied to the gate.

The fixed current generator unit 1 generates a fixed current 11 from the low voltage supply VDD by utilizing a low-voltage supply VDD and a resistance R. The current mirror circuit 2 is comprised of a thin-film NMOSFET Q4 and a thin-film NMOSFET Q2 and outputs a fixed current I2 in a quantity proportional to the fixed current I1. The fixed current I1 is supplied to the thin-film NMOSFET Q4 from the drain, and that drain and gate are connected together, and the source is connected to ground GND. The gate of the thin-film NMOSFET Q2 is connected to the gate of the thin-film NMOSFET Q4 and the source of the thin-film NMOSFET Q2 is connected ground GND.

The protective circuit unit 3 is comprised of a thin-film NMOSFET Q1 utilized as a gate ground to protect the thin-film NMOSFET Q2 having a low breakdown voltage in a state where the high-voltage supply VPP has not risen to a sufficiently high level; a diode D2 to prevent the gate-source voltage Vgs of the thin-film NMOSFET Q1 from becoming a negative electrical potential, a diode D1 for preventing an inverse current from flowing into the low-voltage supply VDD, and a thick-film NMOSFET Q3 utilized as a gate ground to protect the thin-film NMOSFET Q2 in a state where the high-voltage supply VPP has risen. The source of the thin-film NMOSFET Q1 is connected to the drain of the thin-film NMOSFET Q2. The anode of the diode D1 is connected to the low-voltage supply VDD, and the cathode is connected to the gate of the thin-film NMOSFET Q1. The anode of the diode D2 is connected to the source of the thin-film NMOSFET Q1, and the cathode is connected to the gate of the thin-film NMOSFET Q1. The source of the thick-film NMOSFET Q3 is connected to the source of the thin-film NMOSFET Q1, and the drain is connected to the drain of the thin-film NMOSFET Q1.

The current mirror circuit unit 4 is comprised of a thick-film PMOSFET Q5 and a thick-film PMOSFET Q6, and outputs a fixed current I3 proportional to the fixed current I2 copied by the current mirror circuit unit 2. The source of the thick-film PMOSFET Q5 is connected to the high-voltage supply VPP, and the drain is connected to the drain of the thin-film NMOSFET Q1 and the gate is connected to the drain. The gate of the thick-film PMOSFET Q6 is connected to the gate of the thick-film PMOSFET Q5, and the source is connected to the high-voltage supply VPP.

The Zener diode unit 5 generates a fixed voltage VN2 at the GND reference from a fixed current I3 copied by the current mirror circuit unit 4 and is therefore comprised of n number of Zener diodes Z1. The anode side of the Zener diode unit 5 is connected to ground (GND) and the cathode side is connected to the drain of the thick-film PMOSFET Q6.

The push-pull circuit 6 is comprised of a thick-film NMOSFET Q7 and a thick-film PMOSFET Q8 for outputting the fixed voltage VN2 to circuits in latter stages. The gate of the thick-film PMOSFET Q8 is connected to the cathode of the Zener diode connected to the drain of the thick-film PMOSFET Q6, and the drain of the thick-film PMOSFET Q8 is connected to the ground (GND). The gate of the thick-film NMOSFET Q7 is connected to the gate of the thick-film PMOSFET Q8, and the source is connected to the source of the thick-film PMOSFET Q8, and the drain of the thick-film NMOSFET Q7 is connected to the high-voltage supply VPP. Moreover, an output terminal OUT1 is connected to the source of the thick-film NMOSFET Q7.

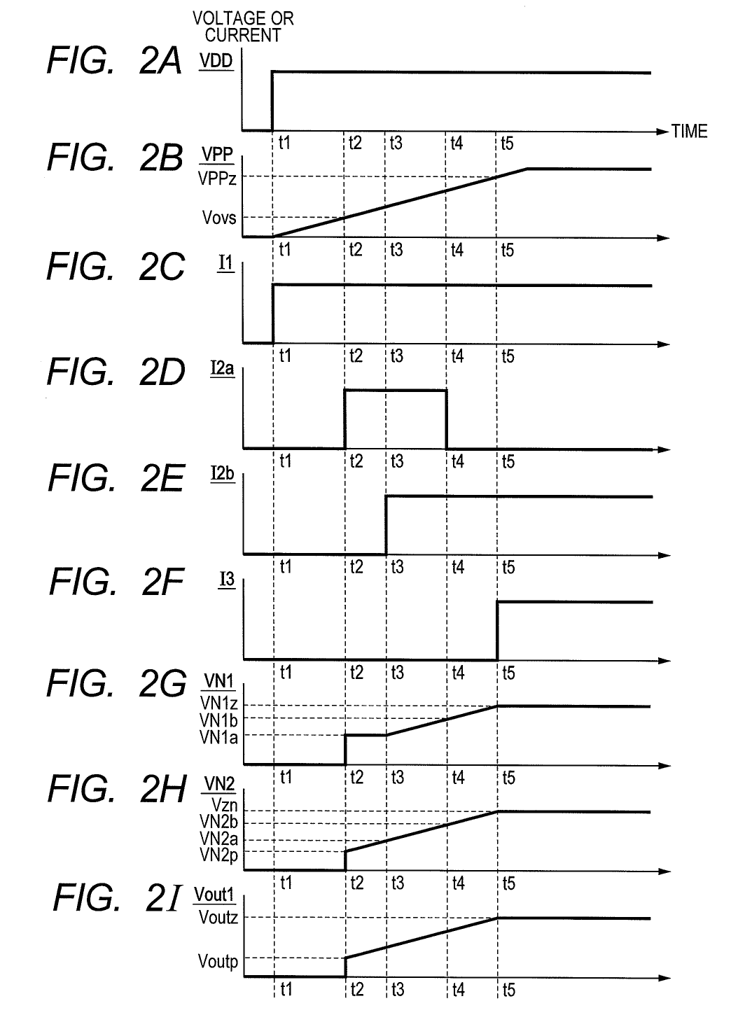

The circuit operation of the voltage level generator circuit shown in FIG. 1 is described next while referring to the operation waveform in FIG. 2A to FIG. 2I. FIG. 2A to FIG. 2I are drawings showing the changes over time from the low-voltage supply VDD startup time t1 respectively for the low-voltage supply VDD, high-voltage supply VPP, fixed current I1, fixed current I2a flowing in the thin-film NMOSFET Q1, fixed current I2b flowing in the thick-film NMOSFET Q3, fixed current I3, voltage VN1 of node N1, voltage VN2 of node N2, and the output voltage Vout1.

When the low-voltage supply VDD rises at time t1 as shown in FIG. 2A, the fixed current I1 generated by the fixed current generator unit 1 flows at time t1 as shown in FIG. 2C. The high-voltage supply VPP rises from time t1 at a certain through-rate as shown in FIG. 2B.

At time t2, when the high-voltage supply VPP along with the overdrive voltage Vov5 of thick-film PMOSFET Q5, the overdrive voltage Vov1 of the thin-film NMOSFET Q1, and the overdrive voltage Vov2 of the thin-film NMOSFET Q2 all sum together to reach the voltage Vovs, and the current I1 is copied by the current mirror circuit unit 2. The current I2a is then able to flow at time t2 in the thick-film PMOSFET Q5, and the thin-film NMOSFET Q1, and the thin-film NMOSFET Q2 as shown in FIG. 2D. The overdrive voltage referred to here is the source-drain voltage required for current saturation across the source-drain.

At time t2, the gate-source voltage Vgs of thick-film PMOSFET Q6 reaches a threshold voltage Vth6 or higher and turns on when the current I2a flows. The voltage VN2 in the node N2 follows up on (is slaved to) the VPP, until the Zener diode Z1 turns on so that the voltage VN2 at the time t2 is a voltage equivalent to the high-voltage supply VPP at time t2. Afterwards, as shown in FIG. 2H, the voltage VN2 rises along with the high-voltage supply VPP. The voltage of the voltage VN2 at time t2 is set to the voltage value VN2p.

At time t3, when the voltage VN2 rises, until the gate-source voltage Vgs of thick-film NMOSFET Q3 exceeds the threshold voltage Vth3 of thick-film NMOSFET Q3, then the current I2b flows in the thick-film NMOSFET Q3 as shown in FIG. 2E. The voltage value of the voltage VN2 at time t3 is set to the voltage value VN2a.

The voltage VN1 of node N1 rises at time t2 as shown in FIG. 2G. The voltage VN1 at time t2 is set to the voltage value VN1a. The flow of current I2B at time t3 causes the voltage VN1 to rise, and when the gate-source voltage Vgs of the thin-film NMOSFET Q1 becomes smaller than the threshold voltage Vth1 of the thin-film NMOSFET Q1, then the thin-film NMOSFET Q1 turns off. The current I2a therefore no longer flows at time t4 as shown in FIG. 2D. The value of the voltage of VN1 at this time is the voltage value VN1b, and the value of the voltage VN2 is set to the voltage value VN2b.

When the voltage VN2 has reached a voltage Vzn at time t5 that is x number of times the Zener voltage Vz1 in each of x number of the Zener diodes Z1, then the current I3 flows in the thick-film PMOSFET Q6 and the Zener diode unit 5 as shown in FIG. 2F. The voltage VN1 at this time reaches a low value lower than the voltage Vzn by an amount equal to the gate-source voltage Vgs, and the voltage value is set to the voltage value VN1z at this time.

A voltage lower than the voltage VN2 by an amount equal to the threshold voltage Vth7 of the thick-film PMOSFET Q7 and constantly present at the output terminal OUT1 of the push-pull circuit 6 as shown in FIG. 2I is output as the output voltage Vout1. The voltage value of voltage Vout1 at time t2 is set as the voltage value Voutp, and the voltage value of the voltage Vout1 at time t5 is set as the voltage value Voutz. The voltage value of the high-voltage supply VPP at time t5 is set as VPPz.

Therefore in the voltage level generator circuit of the present embodiment, even if the high-voltage supply VPP has not risen to a sufficiently high level in the period between time t2 and time t3, then the gate-grounded thin-film NMOSFET Q1 clamps the voltage VN1 at the voltage value VN1a, and the thin-film NMOSFET Q2 having a low breakdown voltage can be protected. The gate-grounded thick-film NMOSFET Q3 turns on from time t3 onward and the thin-film NMOSFET Q1 turns off so that the gate-grounded of the thick-film NMOSFET Q3 protects the thin-film NMOSFET Q2 having a low breakdown voltage. Even if the high-voltage supply VPP rises from time t5 onwards, the voltage VN1 is clamped at the voltage value VN1z, and so the thin-film NMOSFET Q2 having a low breakdown voltage can be protected.

The embodiment structure includes the thin-film NMOSFET Q1 and thick-film NMOSFET Q3 that function as gate grounds in this way to protect the thin-film NMOSFET Q2 having a low breakdown voltage. That gate voltage can then be generated from the low-voltage supply VDD and the high-voltage supply VPP. Restated in other words, no external power supply is needed to generate a gate voltage for the gate grounds.

A fixed output voltage Voutz is output to the output voltage Vout1 at time t5 onwards. If the high-voltage supply VPP is the voltage value VPPz or higher, then the output voltage Vout1 is fixed at the voltage value Voutz.

The present embodiment as described above is therefore a voltage level generator circuit having the features of requiring no external power supply for protecting thin-film MOSFET having low breakdown voltages, and can moreover generate a fixed voltage while protecting thin-film MOSFET having low breakdown voltages and can output a fixed voltage even if the VPP fluctuates, even in cases where the high-voltage supply VPP has not risen to a sufficiently high level.

### Second Embodiment

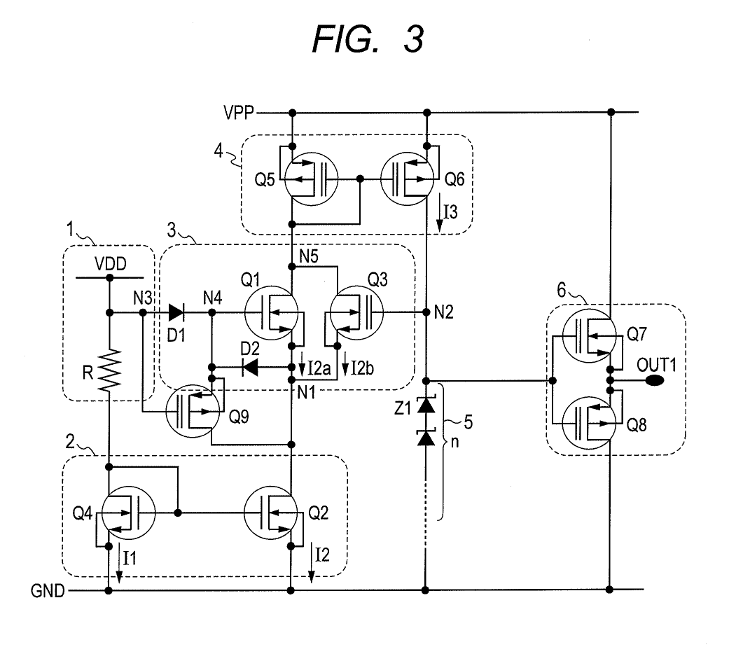

FIG. 3 is a circuit diagram showing an example of the structure of the voltage level generator circuit of the second embodiment. A feature of the present embodiment is that the protective circuit unit 3 of the voltage level shift circuit in FIG. 1, includes a thick-film PMOSFET Q9 whose gate is connected to the node N3, whose source is connected to the node N4, and whose drain is connected to the node N1. This structure can therefore function to prevent device breakdown due to the thin-film MOSFET Q1 turning on, even when the high-voltage supply VPP fluctuates, and the voltage of the node N4 rises due to capacitive coupling.

The circuit operation in the second embodiment is described next while referring to the operation waveforms in FIG. 2. At time t3, the current I2b flows causing the voltage VN1 to rise, and if the gate-source voltage Vgs of the thin-film NMOSFET Q1 has become lower than the threshold voltage Vth1 of the thin-film NMOSFET Q1 then the thin-film NMOSFET Q1 turns off. The flow of current I2a therefore stops at time t4 as shown in FIG. 2D.

However, there is parasitic capacitance among the nodes in the integrated circuit and therefore parasitic capacitance between the high-voltage supply VPP and node N4. Namely, the thin-film NMOSFET Q1 turns on again when the high-voltage supply VPP fluctuates, the voltage VN4 in node N4 rises due to the capacitive coupling, and the gate-source voltage Vgs in thin-film NMOSFET Q1 is the same or higher than the threshold voltage Vth1.

The voltage VN5 of node N5 becomes a lower voltage just by an amount equal to the source-drain voltage Vsd of the thick-film PMOSFET Q5 from the high-voltage supply VPP. The thin-film NMOSFET Q1 on the other hand has a low breakdown voltage between the source-drain and so the device is unable to withstand the voltage and breaks down.

In the present embodiment however, a thick-film PMOSFET Q9 is formed with its gate connected to the low-voltage supply VDD, and its source connected to the node N4. The voltage VN4 becomes a voltage lower than the voltage N1 by an amount equal to the voltage Vf2 along the direction of the diode D2, and upon reaching a voltage sufficiently higher than the low-voltage supply VDD, then the gate-source voltage Vgs of the thick-film PMOSFET Q9 becomes the same or higher than the threshold voltage Vth9. The thick-film PMOSFET Q9 is therefore always on while the thick-film NMOSFET Q3 is on so that the gate and the source of the thin-film NMOSFET Q1 are in a state where electrically shorted at a low-impedance. The above arrangement as already described prevents the thin-film NMOSFET Q1 from turning on again due to capacitive coupling even if there are fluctuations in the high-voltage supply VPP. All other operations are the same as the first embodiment.

The present embodiment as described above requires no external power supply for protecting thin-film MOSFET having low breakdown voltages and is capable of generating a fixed voltage while protecting thin-film MOSFET having a low breakdown voltage even when the high-voltage supply VPP has not risen to a sufficiently high level, and can output a fixed voltage even if the VPP fluctuates. Moreover, a unique feature of the present embodiment is that a level generator circuit can be configured that prevents the thin-film NMOSFET Q1 from turning on again and the device being destroyed even if the high-voltage supply VPP fluctuates, and the node N4 voltage rises due to capacitive coupling.

### Third Embodiment

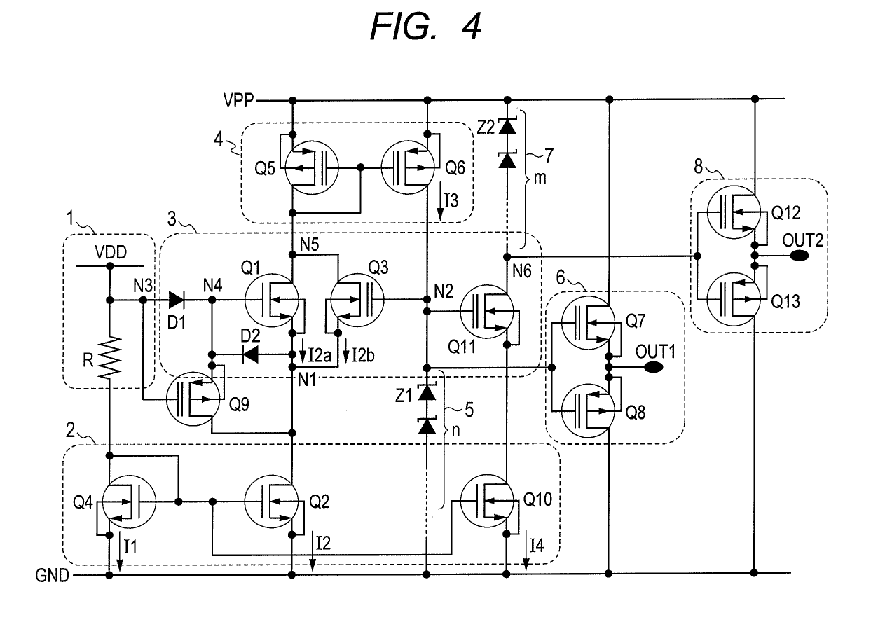

FIG. 4 is a circuit diagram showing an example of the structure of the voltage level generator circuit of the third embodiment. One feature of this embodiment is that the voltage level generator circuit in FIG. 3 is further comprised of a Zener diode unit 7 including m number of Zener diodes Z2 for generating a fixed supply voltage using the high-voltage supply VPP as the reference; a thin-film NMOSFET Q10 to output a large current proportional to the current I1; a thick-film NMOSFET Q11 utilized as a gate ground for protecting the thin-film NMOSFET Q10 having a low breakdown voltage; and a push-pull circuit 8 including a thick-film NMOSFET Q12 and a thick-film PMOSFET Q13 for outputting the voltage VN6 of node N6 to the latter stage circuits.

The source of the thin-film NMOSFET Q10 is connected to ground (GND) and the gate is connected to the gate of the thin-film NMOSFET Q4. The source of the thick-film NMOSFET Q11 is connected to the drain of the thin-film NMOSFET Q10 and the gate of the NMOSFET Q11 is connected to the cathode of the Zener diode on the side nearest of the high-voltage supply VPP in the Zener diode unit 5. Further, the anode of the Zener diode unit 7 is connected to the drain of the thick-film NMOSFET Q11, and the cathode side is connected to the high-voltage supply VPP.

Moreover, the gate of the thick-film NMOSFET Q12 is connected to the gate of the thick-film PMOSFET Q13, the source is connected to the source of the thick-film PMOSFET Q13, and the drain is connected to the high-voltage supply VPP. The gate of the thick-film PMOSFET Q13 is connected to the anode of the Zener diode connected to the drain of the thick-film NMOSFET Q11, and the drain is connected to ground (GND). The source of the thick-film NMOSFET Q12 is connected to the output terminal OUT2.

In addition to generating a fixed voltage for the GND reference by the voltage level generator circuit of the present embodiment as shown in the first embodiment, the Zener diode unit 7 can generate a voltage VN6 of the node N6 from the voltage taking the voltage value Vzm that is x number of times the Zener voltage Vz1 of m number of Zener diodes from the high-voltage supply VPP.

The voltage level generator circuit outputs the voltage VN6 from the push-pull circuit 8, as the voltage Vout2. The embodiment also includes a thick-film NMOSFET Q11 utilized as a gate ground the same as in the first embodiment, in order to protect the NMOSFET Q10 having a low breakdown voltage.

The embodiment as described above can therefore provide a voltage level generator circuit comprised of a Zener diode unit for generating a voltage level for ground (GND) or a high-voltage supply VPP reference, a thin-film NMOSFET for copying the electrical current of the current I1, a thick-film NMOSFET utilized as a gate ground for protecting the thin-film NMOSFET having a low breakdown voltage, a push-pull circuit comprised of a thick-film NMOSFET and a thick-film PMOSFET for outputting a voltage generated from the Zener diode unit to a subsequent stage circuits, and a desired number of output terminals to match the number of desired outputs from adding each of the above components.

The basic operation of the present embodiment is the same as the first embodiment or the second embodiment. The present embodiment as described above requires no external power supply for protecting thin-film MOSFET having a low breakdown voltage and is capable of generating a fixed voltage while protecting thin-film MOSFET having a low breakdown voltage even when the high-voltage supply VPP has not risen to a sufficiently high level, and can also output a fixed voltage even if the VPP fluctuates. Further, the present embodiment unique in that a voltage level generator circuit can be configured to prevent the thin-film NMOSFET Q1 from turning on again and the device being destroyed even if the high-voltage supply VPP fluctuates, and the node N4 voltage rises due to capacitive coupling. The present embodiment also provides a level shift circuit capable of generating a fixed voltage based on the ground (GND) reference or the VPP reference in the desired quantity.

### Fourth Embodiment

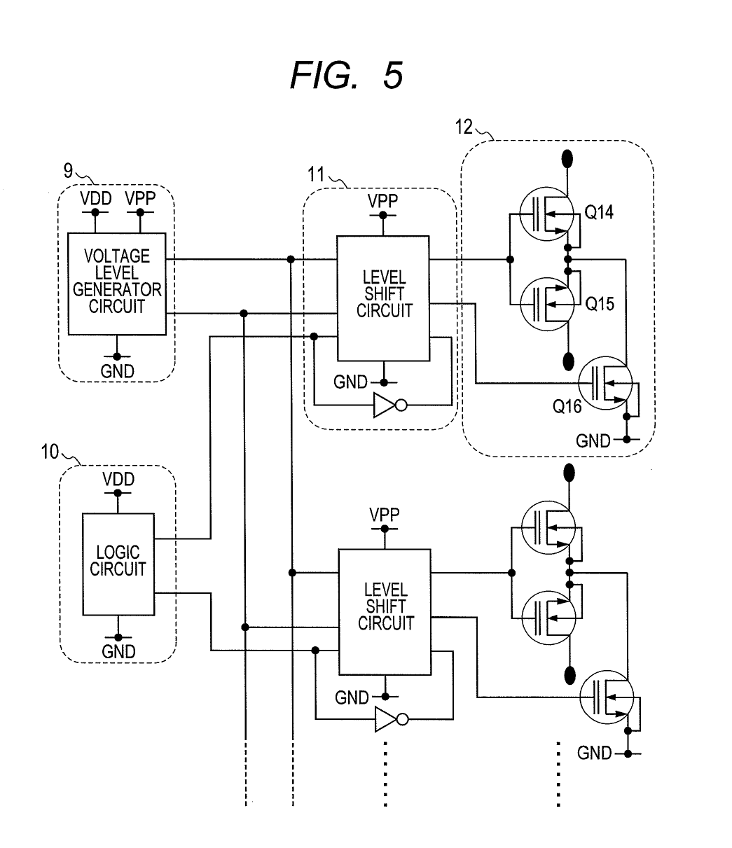

FIG. 5 is a circuit diagram showing one example when the voltage level generator circuit described in the third embodiment is mounted on an integrated circuit comprised of high-breakdown voltage switches including thick-film NMOSFET etc., and level shift circuit for turning the high-breakdown voltage switches on or off, and logic circuits.

The structural contents of FIG. 5 are described next. This structure is comprised of a voltage level generator circuit 9 with the circuit structure shown in FIG. 4, a high-breakdown voltage switch 12 including a thick-film NMOSFET Q14, thick-film NMOSFET Q15, and thick-film NMOSFET Q16, a level shift circuit 11 for turning the high-breakdown voltage switch 12 on and off, and a logic circuit 10 for controlling the level shift circuit 11.

The level shift circuit 11 may be mounted in a quantity to match the desired number of high breakdown voltage switches 12. The level shift circuit 11 is a circuit for shifting the level of (or level shifting) the signal of a voltage identical to the low-voltage supply VDD to the same voltage as the high-voltage supply VPP.

The logic circuit 10 controls the level shift circuit 11 with the same voltage signals as the low-voltage supply VDD and therefore utilizes thin-film MOSFET having a low threshold voltage Vth in the signal input section of the level shift circuit 11. The logic circuit 10 therefore requires a gate-grounded MOSFET in order to protect the thin-film MOSFET having a low breakdown voltage. The integrated circuit shown in FIG. 5 is utilizable for providing a gate-grounded voltage serving as a fixed voltage requiring no external power supply, and capable of generating a fixed voltage based on the ground (GND) reference or the high-voltage supply VPP reference generated by the voltage level generator circuit shown in FIG. 4.

The present embodiment can be configured as an integrated circuit utilizing a voltage level generator circuit for generating for example a fixed voltage for ground (GND) reference or a fixed voltage for a high-voltage supply VPP reference in the desired quantity required as grounded gate voltages for low-breakdown voltage protection, and requiring only a low-voltage supply VDD and high-voltage supply VPP as the required power supply.

The present invention is not limited to the embodiments described above and as is apparent to one skilled in the art, may utilize all manner of variations and adaptations conforming to the spirit and scope of the present invention.

1. A voltage level generator circuit comprising:
a fixed current generator unit to generate a first electrical current in a fixed quantity from a first supply voltage;
a first current mirror circuit unit including a first thin-film NMOSFET that is supplied a first electrical current via a drain, whose gate is connected to the drain, and whose source is connected to a second supply voltage, and a second thin-film NMOSFET whose gate is connected to the first thin-film NMOSFET, and whose source is connected to the second supply voltage and that outputs a second electrical current proportional to the first electrical current;
a protective circuit unit including a third thin-film NMOSFET whose source is connected to the drain of the second thin-film NMOSFET, a first diode whose anode is connected to the first supply voltage and whose cathode is connected to the gate of the third thin-film NMOSFET, a second diode whose anode is connected to the source of the third thin-film NMOSFET and whose cathode is connected to the gate of the third thin-film NMOSFET, and a first thick-film NMOSFET whose source is connected to the source of the third thin-film NMOSFET and whose drain is connected to the drain of the third thin-film NMOSFET;
a second current mirror circuit unit including a first thick-film PMOSFET whose source is connected to the third supply voltage, whose drain is connected to the drain of the third thin-film NMOSFET and whose gate is connected to the drain, and a second thick-film PMOSFET whose gate is connected to the gate of the first thick-film PMOSFET, whose source is connected to the third supply voltage, and that outputs a third electrical current proportional to the second electrical current; and
a first Zener diode unit including n number of first Zener diodes, whose anodes are connected to the second voltage supply and whose cathodes are connected to the drain of the second thick-film PMOSFET.

2. The voltage level generator circuit according to claim 1, further comprising:
a first push-pull circuit including:
a third thick-film PMOSFET whose gate is connected to the cathode of the first Zener diode connected to the drain of the second thick-film PMOSFET, and whose drain is connected to the second supply voltage,
a second thick-film NMOSFET whose gate is connected to the gate of the third thick-film PMOSFET, whose source is connected to the source of the third thick-film PMOSFET, and whose drain is connected to the third supply voltage, and
a first output terminal connected to the source of the second thick-film NMOSFET.

3. The voltage level generator circuit according to claim 1, further comprising:
a fourth thick-film PMOSFET whose gate is connected to the first supply voltage, whose source is connected to the gate of the third thin-film NMOSFET, and whose drain is connected to the source of the third thin-film NMOSFET.

4. The voltage level generator circuit according to claim 1, further comprising:
a fourth thick-film PMOSFET to set a low impedance state between the gate-source of the third thin-film NMOSFET to prevent the third thin-film NMOSFET from transitioning from the off state to the on state due to capacitive coupling between the third supply voltage, and a contact point with the third thin-film NMOSFET and the first diode.

5. The voltage level generator circuit according to claim 1 comprising:
a fourth thin-film NMOSFET whose source is connected to the second supply voltage, whose gate is connected to the gate of the first thin-film NMOSFET, and that outputs a fourth electrical current proportional to the first electrical current;
a third thick-film NMOSFET whose source is connected to the drain of the fourth thin-film NMOSFET, whose gate is connected to the cathode that is nearest the third supply voltage side of the first Zener diode; and
a second Zener diode unit including m number of second Zener diodes, whose anodes are connected to the drain of the third thick-film NMOSFET and whose cathodes are connected to the third supply voltage.

6. The voltage level generator circuit according to claim 5, further comprising:
a second push-pull circuit including:
a fifth thick-film PMOSFET whose gate is connected to the anode of the second Zener diode connected to the drain of the third thick-film PMOSFET, and whose drain is connected to the second supply voltage,
a fourth thick-film NMOSFET whose gate is connected to the gate of the fifth thick-film PMOSFET, and whose source is connected to the source of the fifth thick-film PMOSFET, and whose drain is connected to the third supply voltage, and
a second output terminal connected to the source of the fourth thick-film NMOSFET.

7. A voltage level generator circuit comprising:
a fixed current generator unit to generate a first electrical current in a fixed quantity from the first supply voltage,
a first current mirror circuit including a first thin-film NMOSFET and a second thin-film NMOSFET to output a second electrical current proportional to the first electrical current,
a protective circuit unit including a third thin-film NMOSFET utilized as a gate ground to protect the second thin-film NMOSFET, a first diode to prevent the flow of inverse current into the first power supply, a second diode to prevent the gate-source voltage of the third thin-film NMOSFET from reaching a negative electrical potential, a first thick-film PMOSFET utilized as a gate ground to protect the second thin-film NMOSFET,
a second current mirror circuit unit including a first thick-film PMOSFET and a second thick-film PMOSFET to output a third electrical current proportional to the second electrical current, and
a first Zener diode unit including x number of first Zener diodes to generate a first fixed voltage from the third electrical current.

8. The voltage level generator circuit according to claim 7, further comprising:
a first push-pull circuit including a third thick-film PMOSFET and a second thick-film NMOSFET, to output the first fixed voltage to the latter stage circuits.

9. The voltage level generator circuit according to claim 7, further comprising:
a fourth thick-film PMOSFET whose gate is connected to the first supply voltage, whose source is connected to the gate of the third thin-film NMOSFET, and whose drain is connected to the source of the third thin-film NMOSFET.

10. The voltage level generator circuit according to claim 7, further comprising:
a fourth thick-film PMOSFET to set a low impedance state between the gate-source of the third thin-film NMOSFET to prevent the third thin-film NMOSFET from transitioning from the off state to the on state due to capacitive coupling between the third supply voltage, and a contact point with the third thin-film NMOSFET and the first diode.

11. The voltage level generator circuit according to claim 7, further comprising:
a fourth thin-film NMOSFET to output a fourth electrical current proportional to the first electrical current;
a third thick-film NMOSFET utilized as a gate ground to protect the fourth thin-film NMOSFET; and
a second Zener diode unit including m number of second Zener diodes to generate a second fixed voltage from the fourth electrical current.

12. The voltage level generator circuit according to claim 11, further comprising:
a second push-pull circuit including a fifth thick-film PMOSFET and a fourth thick-film NMOSFET, to output the second fixed voltage to the latter stage circuits.
